(19) United States
(12) Patent Application Publication
(10) Pub. No.: US 2008/0034019 A1
(43) Pub. Date: Feb. 7, 2008

(54) System for multi-device electronic backup

(76) Inventors: Pavel Cisler, Los Gatos, CA (US); Steve Ko, San Francisco, CA (US); Kevin Tiene, Cupertino, CA (US); Robert Ulrich, San Jose, CA (US); Eric Weiss, San Francisco, CA (US)

Correspondence Address: FISH & RICHARDSON P.C., PO BOX 1022, MINNEAPOLIS, MN, 55440-1022, US

(21) Appl. No.: 11/499,840

(22) Filed: Aug. 4, 2006

(51) Int. Cl. G06F 17/30

(52) U.S. Cl. 707/204

(57) ABSTRACT

A system creates electronic backups on one or more devices. In one implementation, a method is provided. A backup operation is initiated for a system. The backup operation is configured to store backup data to a storage device. A determination is made as to whether the system is coupled to the storage device. Backup data is stored locally if the system is not coupled to the storage device.

### RELATED APPLICATIONS

This application is generally related to the following jointly owned and co-pending patent applications, each incorporated herein by reference in its entirety:
U.S. patent application Ser. No. ______, for “Managing Backup of Content,” filed Aug. 4, 2006;
U.S. patent application Ser. No. ______, for “User Interface for Backup Management,” filed Aug. 4, 2006;
U.S. patent application Ser. No. ______, for “Navigation of Electronic Backups,” filed Aug. 4, 2006;
U.S. patent application Ser. No. ______, for “Architecture for Back Up and/or Recovery of Electronic Data,” filed Aug. 4, 2006;
U.S. patent application Ser. No. ______, for “Searching a Backup Archive,” filed Aug. 4, 2006;
U.S. patent application Ser. No. ______, for “Application-Based Backup-Restore of Electronic Information,” filed Aug. 4, 2006;
U.S. patent application Ser. No. ______, for “Conflict Resolution in Recovery of Electronic Data,” filed Aug. 4, 2006;
U.S. patent application Ser. No. ______, for “System for Electronic Backup,” filed Aug. 4, 2006;
U.S. patent application Ser. No. ______, for “Restoring Electronic Information,” filed Aug. 4, 2006;
U.S. patent application Ser. No. ______, for “Links to a Common Item in a Data Structure,” filed Aug. 4, 2006;
U.S. patent application Ser. No. ______, for “Event Notification Management,” filed Aug. 4, 2006;
U.S. patent application Ser. No. ______, for “Consistent Back Up of Electronic Information,” filed Aug. 4, 2006.

### TECHNICAL FIELD

The disclosed implementations relate generally to storing and restoring data.

### BACKGROUND

A hallmark of modern graphical user interfaces is that they allow a large number of graphical objects or items to be displayed on a display screen at the same time. Leading personal computer operating systems, such as Apple Mac OS®, provide user interfaces in which a number of windows can be displayed, overlapped, resized, moved, configured, and reformatted according to the needs of the user or application. Taskbars, menus, virtual buttons and other user interface elements provide mechanisms for accessing and activating windows even when they are hidden behind other windows.

With the sophisticated tools available, users are encouraged not only to create and save a multitude of items in their computers, but to revise or otherwise improve on them over time. For example, a user can work with a certain file and thereafter save its current version on a storage device. The next day, however, the user could have had second thoughts about the revisions, or could have come up with new ideas, and therefore opens the file again.

The revision process is usually straightforward if the user wants to add more material to the file or make changes to what is there. But it is typically more difficult for a user who has changed his/her mind about changes that were previously made and wants the file back as it was once before. Application programs for word processing typically let the user “undo” previous edits of a text, at least up to a predefined number of past revisions. The undo feature also usually is configured so that the previously made revisions must be undone in reverse chronological order; that is, the user must first undo the most recently made edit, then the second-most recent one, and so on. If the user saves and closes the document and thereafter opens it again, it might not be possible to automatically undo any previous edits.

### SUMMARY

Systems and methods are provided for backup operations. When a device (e.g., a portable computer) is disconnected from an external storage device used for backup operations, temporary backups can be stored locally. Once reconnected to the external storage device, the backup can be synced using the local temporary backups.

In general, in one aspect, a method is provided. A backup operation is initiated for a system. The backup operation is configured to store backup data to a storage device. A determination is made as to whether the system is coupled to the storage device. Backup data is stored locally if the system is not coupled to the storage device.

Implementations of the method can include one or more of the following features. The method can further include determining that the system is re-coupled to the external storage device and updating the external storage device with the internally stored backup data. Storing backup data internally can include storing a full copy of data to be included in the backup. Storing backup data internally can include storing changed data from a previous backup operation. Storing backup data can include storing data in as a hierarchical file system. Initiating the backup operation can include initiating the backup operation according to a schedule. Initiating the backup operation can include initiating the backup operation according to one or more triggering events.

Updating the external storage device can include copying backup data from the system to the storage device. The method can further include storing additional incremental backup data locally until re-coupled to the storage device. Determining whether the system is coupled can include detecting a presence of one or more storage devices. Determining whether the system is coupled can include receiving a user input indicating that the system is not coupled to a storage device. The method can further include receiving a user input to store backup data locally. The storage device can be external to the system. Storing the backup data locally can include storing the backup data internally.

In general, in another aspect, a method is provided. A backup operation for a system is initiated. The backup operation is configured to store backup data to a storage device. A determination is made as to whether the system is coupled to the storage device. Backup data is stored on an alternative storage device if the storage device is unavailable.

In general, in one aspect, a method is provided. A device is disconnected from a first remote storage device. Backup data is stored locally while the remote storage device is disconnected a second remote storage device is connected to the device. A second remote storage device is coupled to the device. The locally stored backup data is synced with backup data stored on the second remote storage device.

Implementations of the method can include one or more of the following features. The first and second storage devices can be the same device. The syncing can include comparing the locally stored backup data with the backup data stored on the remote storage device and storing changed data from the data stored on the remote storage device.

In general, in one aspect, a method is provided. A device with local storage is provided. A remote storage device is provided. The remote storage device is coupled intermittently with the device. A backup application is provided for storing a state of the device or a state of applications executing on the device. A determination is made as to if the device is coupled to the remote storage device. If the device is coupled to the remote storage device, data from backup application is stored on the remote storage device. If the device is not coupled to the remote storage device, data from the backup application is stored on the local storage. If the device is re-coupled to the remote storage device, backup data stored on the local storage is synced with backup data stored on the remote storage device.

In general, in one aspect, a method is provided. A criterion is defined for capturing a state of a view of a user interface of a device. The state of the view is captured in accordance with the criterion. A determination is made as to if the device is coupled to a remote storage device. If the device is coupled to the remote storage device, the captured state of the view is stored on the remote storage device. If the device is not coupled to the remote storage device, the captured state of the view is stored locally on the device. The method can further include receiving a prompt to suspend presentation of a current view and present a captured view and reinstating the captured view into the current view of the user interface.

Particular embodiments of the subject matter described in this specification can be implemented to realize one or more of the following advantages. A user can maintain backup operations can continue locally while a device is not coupled to a storage device so that information is not lost during the time of de-coupling. Additionally, the data stored locally and the data stored on a storage device can be synced when re-coupled so that the data is consistent. Thus, the user of a portable device such as a portable computer that stored backup data to an external storage device can continue to perform backup operations regardless of the state of the connection with the external storage device.

The details of the various aspects of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram of an example of an architecture for modifying a user interface view in a display environment.

FIG. 2 is a block diagram of an example of an architecture for backing up and restoring application files.

FIG. 3 shows an example of a time machine settings dialog.

FIG. 4 shows an example of a time machine settings dialog for setting backup storage device options.

FIG. 5 shows an example of a time machine settings dialog over which a pop-up window for a particular storage device is displayed.

FIG. 6 is a screen shot depicting an example of a desktop user interface with multiple open applications.

FIG. 7 is a screen shot depicting an example of a time machine user interface generated by a time machine engine.

FIG. 8 is a screen shot depicting an example of a time machine user interface after additional backup information has been recovered.

FIG. 9 is a flow diagram of a method illustrating a multi-device archive management scenario.

### DETAILED DESCRIPTION

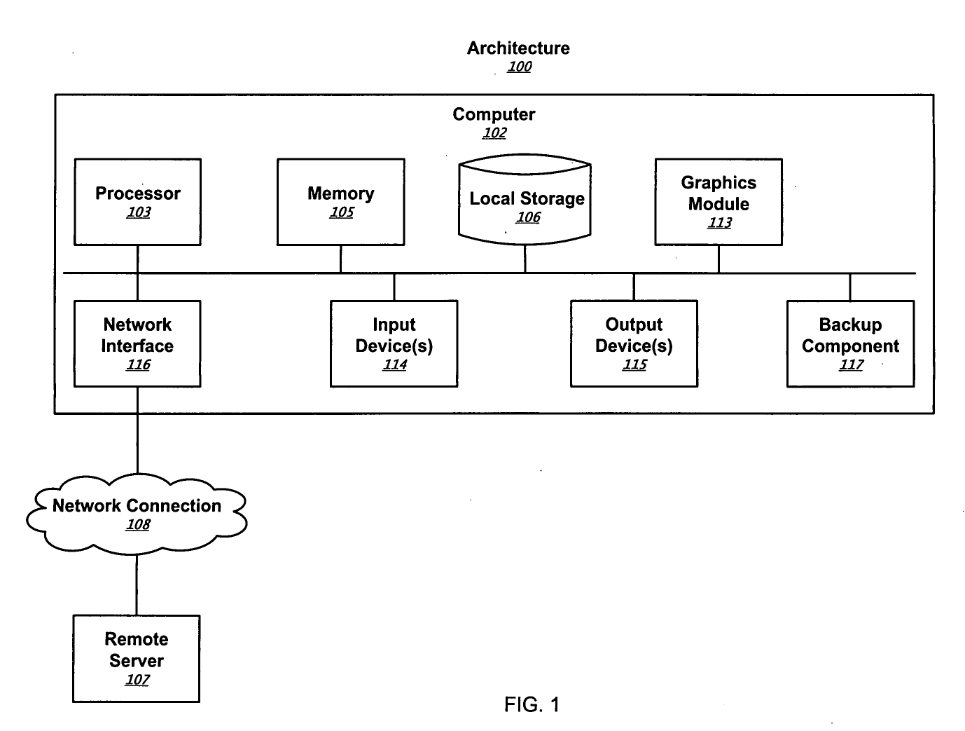

FIG. 1 is a block diagram of an architecture 100 for allowing a user to search a captured version of an interface view, perhaps to initiate a restoration based on it. As used herein, a view refers to an item, element or other content, capable of being presented in a user interface, that can be subjected to a backup operation by the backup component 117. For example, a user interface view can contain any number of icons, files, folders, application state information and/or machine state information, etc. The architecture 100 includes a personal computer 102 communicatively coupled to a remote server 107 via a network interface 116 and a network 108 (e.g., local area network, wireless network, Internet, intranet, etc.). The computer 102 generally includes a processor 103, memory 105, one or more input devices 114 (e.g., keyboard, mouse, etc.) and one or more output devices 115 (e.g., a display device). A user interacts with the architecture 100 via the input and output devices 114, 115. Architecture 100 as disclosed includes various hardware elements. Architecture 100 can include hardware, software, and combinations of the two.

The computer 102 also includes a local storage device 106 and a graphics module 113 (e.g., graphics card) for storing information and generating graphical objects, respectively. The local storage device 106 can be a computer-readable medium. The term “computer-readable medium” refers to any medium that includes data and/or participates in providing instructions to a processor for execution, including without limitation, non-volatile media (e.g., optical or magnetic disks), volatile media (e.g., memory) and transmission media. Transmission media includes, without limitation, coaxial cables, copper wire, fiber optics, and computer buses. Transmission media can also take the form of acoustic, light or radio frequency waves.

While modifications of a user interface view are described herein with respect to a personal computer 102, it should be apparent that the disclosed implementations can be incorporated in, or integrated with, any electronic device that has a user interface, including without limitation, portable and desktop computers, servers, electronics, media players, game devices, mobile phones, email devices, personal digital assistants (PDAs), embedded devices, televisions, other consumer electronic devices, etc.

Systems and methods are provided for storing backup data locally when a system is not coupled to a storage device (e.g., an external storage device). The stored backup data contents can correspond to earlier versions of system information, application information or system, application, or user interface state. The systems and methods can be stand alone, or otherwise integrated into a more comprehensive application.

Though discussion is made with reference to modifying a user interface view, those of ordinary skill will recognize that such a view can be based on various data structures, files, processes, and other aspects of information management. It follows that modification to file structures, data and the like is also contemplated in order to achieve the modification to the user interface view. In other words, while the restoration of the user interface view from one state to another can be the most apparent change from the user's perspective, this is accomplished through the corresponding changes in the underlying system content.

One of ordinary skill in the art will recognize that the engines, methods, processes and the like that are described can themselves be an individual process or application, part of an operating system, a plug-in, an application, or the like. In one implementation, the system and methods can be implemented as one or more plug-ins that are installed and run on the personal computer 102. The plug-ins are configured to interact with an operating system (e.g., MAC OS® X, WINDOWS XP, LINUX, etc.) and to perform the various functions, as described with respect to the Figures. A system and method for modifying a user interface view can also be implemented as one or more software applications running on the computer 102. Such a system and method can be characterized as a framework or model that can be implemented on various platforms and/or networks (e.g., client/server networks, wireless networks, stand-alone computers, portable electronic devices, mobile phones, etc.), and/or embedded or bundled with one or more software applications (e.g., email, media player, browser, etc.).

The computer 102 includes the backup component 117 that allows for the storage of versions of the computer's files or other items, for example within the local storage 106 or in an external storage repository. In one implementation, the backup component 117 also allows a user to select any of the stored versions and use it to initiate a restoration of that version in the computer 102.

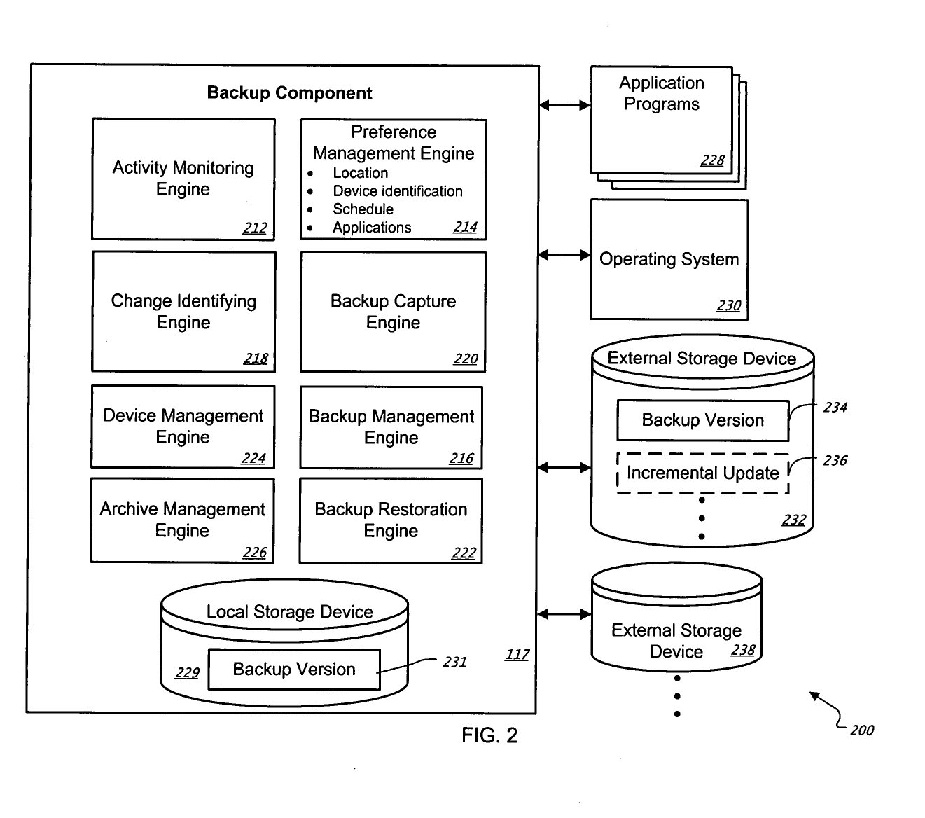

FIG. 2 is a block diagram of an exemplary architecture 200 for enabling the back up and restoration of data (e.g., application files, application data, settings, parameters or the like), such as those associated with a set of application programs 228.

In one implementation, the backup component 117 provides back up and restoration capability for the system. Many different items or elements can be the subject of a back up in the system. For example, folders, files, items, information portions, directories, images, system parameters, playlists, address books, e-mails, e-mail folders, application states, preferences and the like all can be candidates for archiving. Other types are also possible. In this example, the backup component 117 includes a local storage device 229 and two external storage devices, device 232 and device 238. Versions can be stored on any or all of them. Any number of local and/or external storage devices can be used by the backup component 117 for storing versions. In one implementation, no local storage is provided.

In one implementation, the backup component runs as a background task on an operating system 230 such that the background task is not visible to the user. The backup component can be capable of running across multiple user accounts.

The backup component 117 includes an activity monitoring engine 212. In one implementation, the activity monitoring engine 212 monitors for changes within an application view (e.g. files) that are targeted for backup operations. A change can also include the addition of new files or data or the deletion of the same. In one implementation, the activity monitoring engine 212 is capable of discerning between a substantive change (e.g. the text within a document has been modified) and a non-substantive change (e.g. the play count within an iTunes™ playlist has been updated, or several changes cancel each other out) through its interaction with the application programs 228. The activity monitoring engine 212 can, for example, create a list of modified elements to be used when a backup event is eventually triggered. In one implementation, the activity monitoring engine 212 can monitor the system for periods of inactivity. The activity monitoring engine 212 can then trigger a backup event during a period of time in which the backup operation will not cause a system slowdown for an active user.

A preference management engine 214 specifies some operating parameters of the backup component 117. In one implementation, preference management engine 214 contains user-specified and/or system default application parameters for the backup component 117. These can include settings for the details of capturing and storing the earlier versions. For example, the preference management engine 214 can determine the frequency of a backup capture, the storage location for the backup versions, the types of files, data, or other items that are eligible for backup capture, and the events which trigger a backup capture (periodic or event-driven, etc.).

In one implementation, the preference management engine 214 can detect that a new storage device is being added to the system and prompt the user whether it should be included as a backup repository. Files and other items can be scheduled for a backup operation due to location (e.g. everything on the C: drive and within D:/photos), a correlation with specific applications (e.g. all pictures, music, e-mail, address book and system settings), or a combination of strategies. Different types of items can be scheduled to be stored on different devices or on different segments of a storage device during a backup operation. In one implementation, the backup component 117 stores the versions in a format corresponding to a file system structure.

A backup management engine 216 coordinates the collection, storage, and retrieval of view versions performed by the backup component 117. For example, the backup management engine 216 can trigger the activity monitoring engine 212 to watch for activities that satisfy a requirement specified in the preference management engine 214.

A change identifying engine 218 locates specific views or other items within to determine if they have changed. The change identifying engine 218 can be capable of discerning a substantive change from a non-substantive change, similar to the example described above for the activity monitoring engine 212. In one implementation, the change identifying engine 218 traverses a target set of files, data, or other items, comparing a previous version to the current version to determine whether or not a modification has occurred.

A backup capture engine 220 locates files, data, or other items that are to be included in a back up. The backup capture engine 220 can invoke the activity monitoring engine 212 and/or the change identifying engine 218, for example, to generate a capture list. The backup capture engine 220 can then store copies of these elements in one or more targeted storage repositories. The backup capture engine 220 can track multiple version copies of each item included in the backup repository.

The backup component 117 includes a backup restoration engine 222 to restore previous views (e.g. versions of files, data, or other items). In one implementation, the backup restoration engine 222 provides a user interface (e.g., a graphical user interface) where a user can select the item(s) to be restored.

A device management engine 224 handles the addition and removal of individual storage devices to be used for archiving views. Particularly, the device management engine 224 manages backup operations across multiple storage devices. For example, when the backup component 117 does not have access to a network storage device or other user-determined storage device, the device management engine 224 can allow access to another external storage device, such as, for example a USB flash memory storage device. In some implementations, the user can choose to store backup information internally on the computer device 102, rather than store backup information to external storage devices. In one implementation, the preference management engine 214 obtains user settings regarding the identification of individual storage devices for use in archiving. These settings can include, but are not limited to, particular segments of individual devices to use, a threshold capacity for archiving data, and individual applications to archive to each device. The device management engine 224 records the storage device settings obtained by the preference management engine 214 and uses them to monitor storage device activity. In one implementation, the device management engine 224 can alert the user when a new device has been added to the system. In one implementation, the device management engine 224 can alert the user when an archive-enabled device has been removed from the system. In yet another implementation, the device management engine 224 can alert the user when an archive-enabled device is nearing its threshold storage capacity setting.

The local storage device 229 contains an initial backup version 231, which is the first archived view created within this device for a particular item. The local storage device 229 can be used when external storage is not possible, such as when disconnected from a network, or when unable to connect to (or access) a user-determined storage device. In some implementations, the local storage device 229 can be used to copy backup data from the system to the external storage device 232 or 238. For example, when the backup component (e.g., backup component 117) utilizes the local storage device 229 for storing a backup, elements are stored in the local device. In some implementations, the local storage device 229 can contain an incremental update. The incremental update can contain links back to data stored within initial backup 231, such that only one copy of an unchanged piece of data is retained. In this manner, links can also exist between incremental updates. Each incremental update can then contain a copy of each new or changed data item plus a link back to a previously stored copy of each unchanged data item. Any number of incremental updates can exist. If, from one incremental update period to another, the user changes the scope of data that is to be backed up, another backup will be made of the new modifications. At some point in time, the user may wish to transfer the backup data elements temporarily stored on the local storage device 229 to an external storage device. For example, backup data elements can be transferred to external storage when access is made available to the external storage device (e.g., re-coupling to, or detecting the presence of the originally selected storage device). When a transfer occurs, the local storage device 229 and the external storage device can synchronize the elements between the two devices. In some implementations, the local storage device 229 can be the user-selected method of storage, rather than a temporary storage device.

An archive management engine 226 tracks where archived views are being stored. In one implementation, the archive management engine 226 can obtain user options from the preference management engine. Such settings can include, but are not limited to, methods to be used to remove older or otherwise unnecessary archived views. These settings can establish criteria for archived view deletion, for instance in the event of storage capacity being reached or on a regular basis. In one implementation, the archive management engine 226 can alert the user when archives are missing because a device has gone offline. In another implementation, the archive management engine 226 can bar a user from viewing another user's archive data due to system permissions settings.

Any number of storage devices can be used by the backup component 117. A second external storage device 238 can, in one implementation, be used as an overflow repository in the event that the first device 232 reaches capacity. In another implementation, the backup version and incremental updates of data belonging to different applications or to different users on the system can be distributed among more than one device. As another example, two or more storage devices can be responsible for backing up contents from separate applications in the system.

The archived copies can be compressed and/or encrypted. An example of a compression technique is the ZIP file format for data compression and archiving. An example of an encryption technique is the RSA algorithm for public key encryption. Other compression techniques or encryption techniques can be used.

In one implementation, if multiple users make use of the backup component 117 on a single system, each user can choose to keep separate archives. Access to an individual user's archives can be password protected or otherwise held in a secure manner. In one implementation, the archive storage structure mimics a typical file system structure, such that the archived versions can be perused using a standard file system viewing utility.

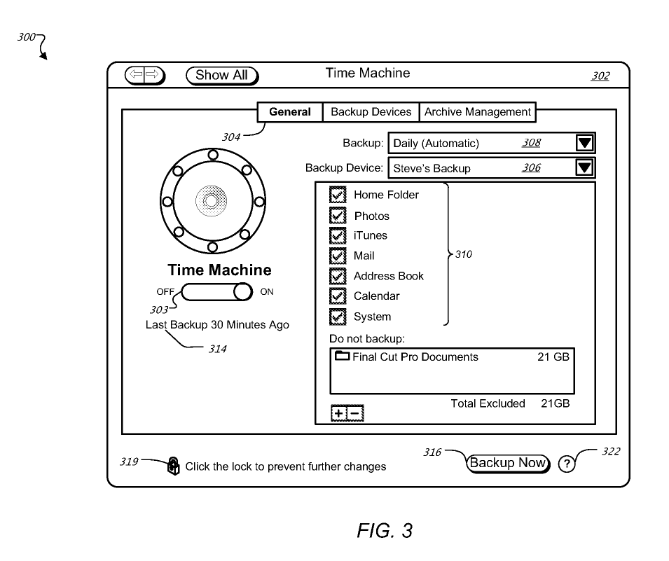

FIG. 3 shows a screen shot 300 depicting an example of a time machine settings dialog 302. In one implementation, the dialog 302 is generated by the preference management engine 214 (FIG. 2). A general settings tab 304 is selected. A user can select a checkbox 306 to establish an automatic backup schedule. The user can select a slide bar control 303 to switch the backup operations on or off. A drop-down menu 308 can be used to set the frequency of making backups (e.g. every day, every week, every other week, or every month, etc.). In another implementation, a time of day or other granularity setting can be available. Such a setting would allow the user to request that the utility run during a typically inactive period, such as overnight. In one implementation, an event-driven trigger can be specified, such as having the backup utility run upon system start-up. In another example of an event-driven trigger, the time machine could be set to back up when there has been activity relating to the item that is to be backed up. In one implementation, the backup can be set to run in periods of inactivity when there is less user demand on system performance.

A set of applications 310 indicates which type(s) of data is eligible for a backup operation. The applications list can contain specific products (e.g. iTunes) and/or general categories (e.g. photos, address book, e-mail inbox). The user can select one or more entries on the list. In one implementation, each application name can be individually selectable. For example, within an internet browser application, the user can set the bookmarks and personal settings to be backed up but not the history or cookies. One implementation can allow a user to select specific disk drives, folders, and/or files for back up.

A message block 314 alerts the user as to the date and time of the last backup event. As shown in FIG. 3, the last backup occurred thirty minutes earlier. In one implementation, this information is obtained from the backup capture engine 220 (FIG. 2). A user can select a backup now button 316 to trigger a backup event. In one implementation, the backup now button 316 calls the backup capture engine 220 (FIG. 2) to initiate a capture event using the settings provided within the time machine settings dialog 302.

If a lock icon 319 is selected, the time machine engine backup configuration is essentially locked into place until the icon 319 is selected again. For example, selecting the lock icon 319 in the settings dialog 302 can ensure that daily (automatic) backup operations are performed using backup device 306 (“Steve's backup device”) as the storage medium until the lock icon 319 is again selected, thus unlocking the current backup configuration.

A user can select a help button 322 to open a help dialog regarding the time machine engine. The help dialog can be presented within the time machine settings dialog 302 or in a separate pop-up window, for example. In another implementation, a mouse over of individual controls within the time machine settings dialog 302 can provide the user with a brief description of that control's functionality.

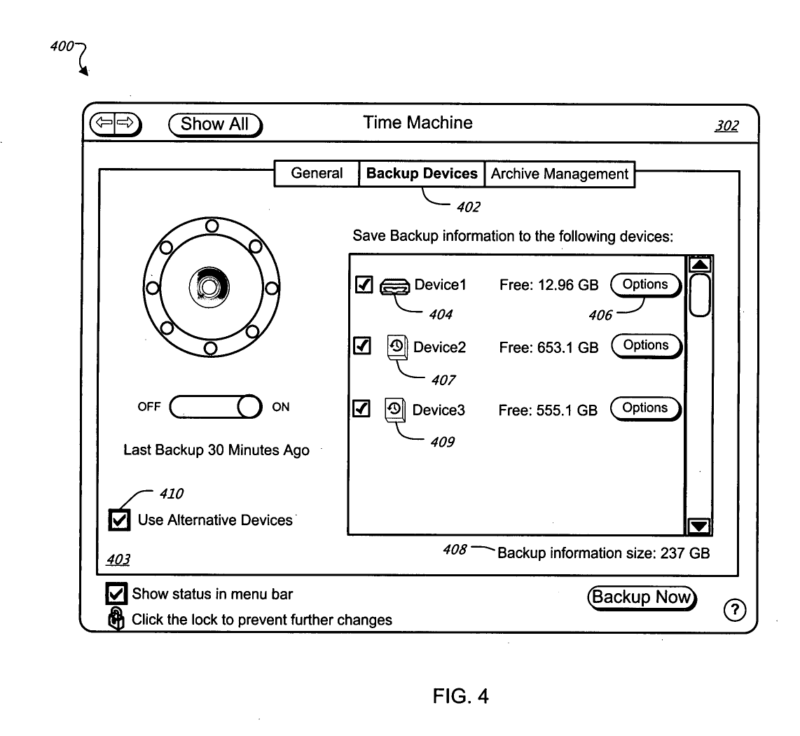

FIG. 4 shows a screen shot 400 depicting an example of the time machine settings dialog 302 in which a backup devices tab 402 is selected. A backup devices view 403 allows the user to select one or more repositories for storing archived items. In this example, a first device 404, a second device 407, and a third device 409 are available for use. A user can select an options button 406 associated with the first device 404 to view a settings dialog for this device. In one implementation, selection of the options button 406 triggers the display of another pop-up window. The icons associated with the first device 404 and the second device 407 can be indicative of the type of the device. For example, the icon associated with the first device 404 is a graphic of an optical drive. An information field 408 informs the user of the present size of the archived information. In this example, the backup information on any or all of the selectable devices (404, 407 and 409) is taking up 237 gigabytes of space.

The backup devices view 403 also includes a “Use Alternative Devices” selection box 410. The “Use Alternative Devices” selection box 410 can be used to indicate that an alternative storage device should be used, such as a USB flash drive, a firewire external hard drive, an optical drive (e.g., a writable CD drive), a floppy disk, a flash memory drive, or other external storage devices, to name a few examples. In addition, the alternative storage device can be one used for internal storage, such as a local back up on the system hard drive. The user can designate an alternative storage device for use when a particular backup device is unavailable. For example, one or more backup devices can be made unavailable when the computer system 102 is disconnected from the network 108 (FIG. 1). In some implementations, the backup device can be unavailable because the computer system 102 is out of range of a particular wireless connection.

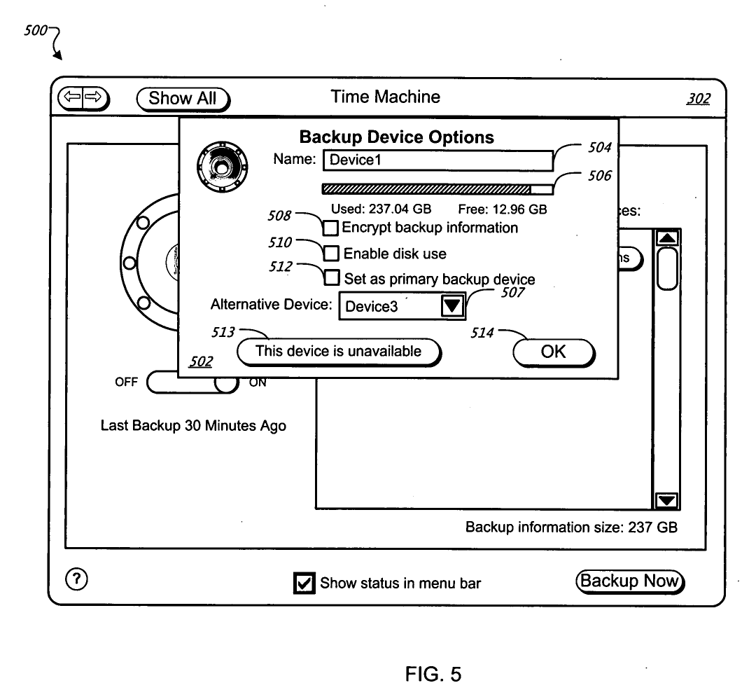

For the next example, the user selects the options button 406 (FIG. 4) and the “Use Alternative Devices” selection box 410. As shown in FIG. 5, a screen shot 500 contains the time machine settings dialog 302 and a pop-up window 502. The pop-up window 502 displays options relating to the first device 404 (FIG. 4). An information field 504 contains the storage device name, in this example “Device 1”. A bar graph 506 illustrates the amount of free space available on the first device 404. According to the text beneath the bar graph, 237.04 gigabytes of memory has been used, and 12.96 gigabytes of memory is free on the first device 404.

In the previous example (FIG. 4), the “Use Alternative Devices” selection box 410 was selected. In the pop-up window 502, the user can select which alternative device to use as an alternative to the primary backup device, by selecting a device from a dropdown menu 507. The dropdown menu 507 can contain several options, any or all of which a user can select. In some implementations, the pop-up window 502 can contain more than one selectable dropdown menu for alternative devices. For example, the user could select a first alternative device and a second alternative device. In some implementations, separate alternative devices can be used for separate applications.

The pop-up window 502 also includes several options for configuring the selected backup device 504. Here, a user can select a checkbox 508 to have the corresponding backup information encrypted. For example, in one implementation, this can cause the existing archives within the associated backup device to be placed in an encrypted format. In another implementation, only the archives generated after the time of selecting the checkbox 508 will be generated in an encrypted format. In one implementation, the backup capture engine 220 (FIG. 2) can create the encrypted copies for the archives. A user can select a checkbox 510 to enable the first device 404 for disk use. For example, this can involve synchronizing the first device with the system. A user can further select a checkbox 512 to set Device 1 as the primary backup device. With these settings, the Device 1 is set for use as a backup device, and if it should become unavailable, the Device 3 will be used instead. Corresponding settings can be made for any storage device, including the Device 3.

In one implementation, the name field 504 can be user-editable to define the storage location in greater detail. For example, a particular segment or segments of a backup device can be selected rather than the entire device. The user can select a “This device is unavailable” button 513 when the status of the selected backup device (shown in information field 504) is known to be missing or disconnected. In this implementation, such a selection causes the time machine to begin using the alternative device for storing backup versions. Upon completing the configuration of the selected backup device, the user can select an OK button 514 to close the popup window 502 and return to the time machine settings dialog 302.

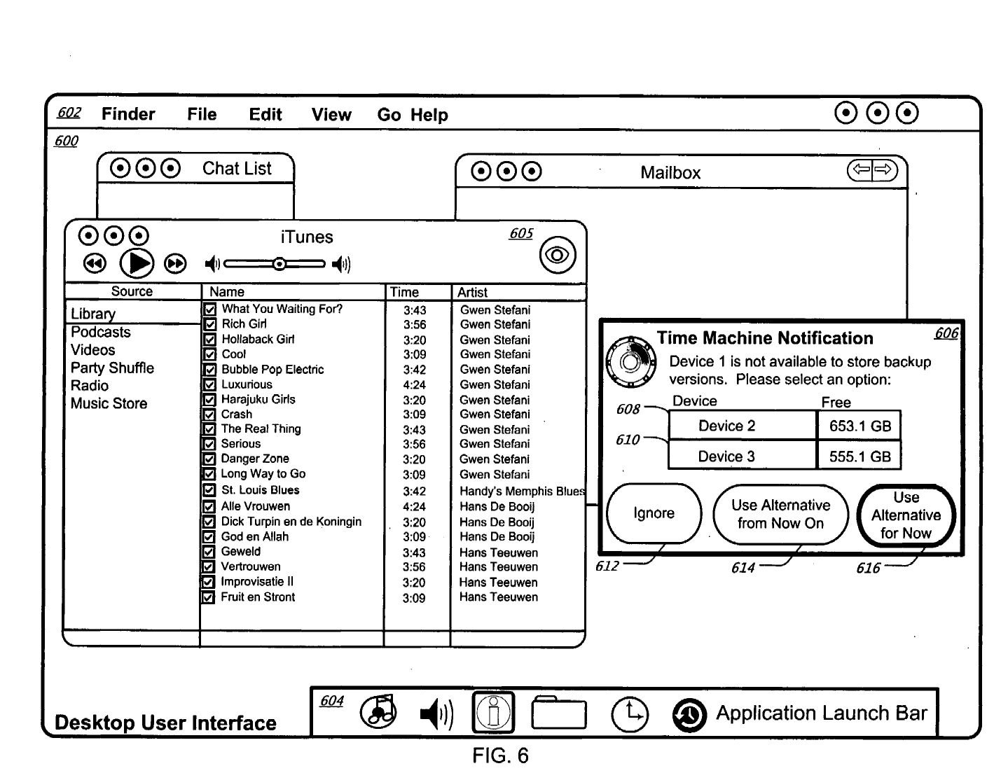

Once the backup device options have been set for a particular application, the user can minimize or exit the time machine settings dialog 302. Exiting or minimizing the time machine settings dialog 302 returns the user to a desktop user interface. FIG. 6 is a screen shot depicting an example of a desktop user interface 600 with multiple open applications. The desktop user interface 600 (also referred to herein as “desktop”) can be a conventional user interface provided by an operating system. The desktop 600 has a background, a menu bar 602, an application launch bar 604, and can include windows, icons, and other elements. Other configurations are possible. The desktop 600 can have multiple applications running, any or all of which can be presented in a separate window.

In this example, a user is accessing an iTunes™ application window 605 (available from Apple Computer in Cupertino, Calif.). The iTunes™ application is here displaying contents of the user's library, which lists the user's songs. The iTunes™ application can be used for accessing, playing and organizing media, such as digital music, pictures and video files. In particular, while the user is here accessing the iTunes™ application window 605, a pop-up window 606 is presented. The pop-up window 606 is a time machine notification to the user regarding a particular unavailable backup device. As described earlier in this description, backup devices can become unavailable, for example when they are disconnected from the network 108 (FIG. 1). Specifically, the pop-up window 606 shows that “Device 1” has become unavailable to store backup versions. Two predetermined alternative backup devices are here presented to the user. A first backup option “Device 2” 608 is shown with 653.1 gigabytes of free space and a second backup option “Device 3” 610 is shown with 555.1 gigabytes of free space. The user can select an ignore button 612 instructing the time machine engine to discontinue backup operations. In some implementations, backup operations can be discontinued until “Device 1” is made available again. In other implementations, backup operations can be discontinued indefinitely pending user interaction to restore backup operations.

In some implementations, the user can temporarily or permanently continue backup operations on alternative storage devices when a primary storage device is unavailable. For example, the user can store new song files obtained for the iTunes™ application 605 on one particular alternative storage device by selecting a “Use Alternative from Now On” button 614. The selected alternative storage device then becomes the primary storage device. In other implementations, the user can make use of alternative storage devices without reassigning the primary storage device for an application. Selecting a “Use Alternative for Now” button 616 can temporarily reassign the location for storing backup versions. For example, relocating a wirelessly enabled laptop outside of the wireless access area can cause the backup storage to be temporarily reassigned to an alternative storage device. In some implementations, the alternative storage device can be the local hard drive of the computer system 102 running the time machine engine. In this example, the user has selected the “Use Alternative for Now” button 616. Upon selecting an option from the time machine notification 606, the user can return to working with the iTunes™ application. While working with the applications, or at some other time, a user can initiate a time machine user interface. In one implementation, when the primary storage device becomes available again, the system can synchronize the primary storage device with the data stored locally or on an alternative storage device.

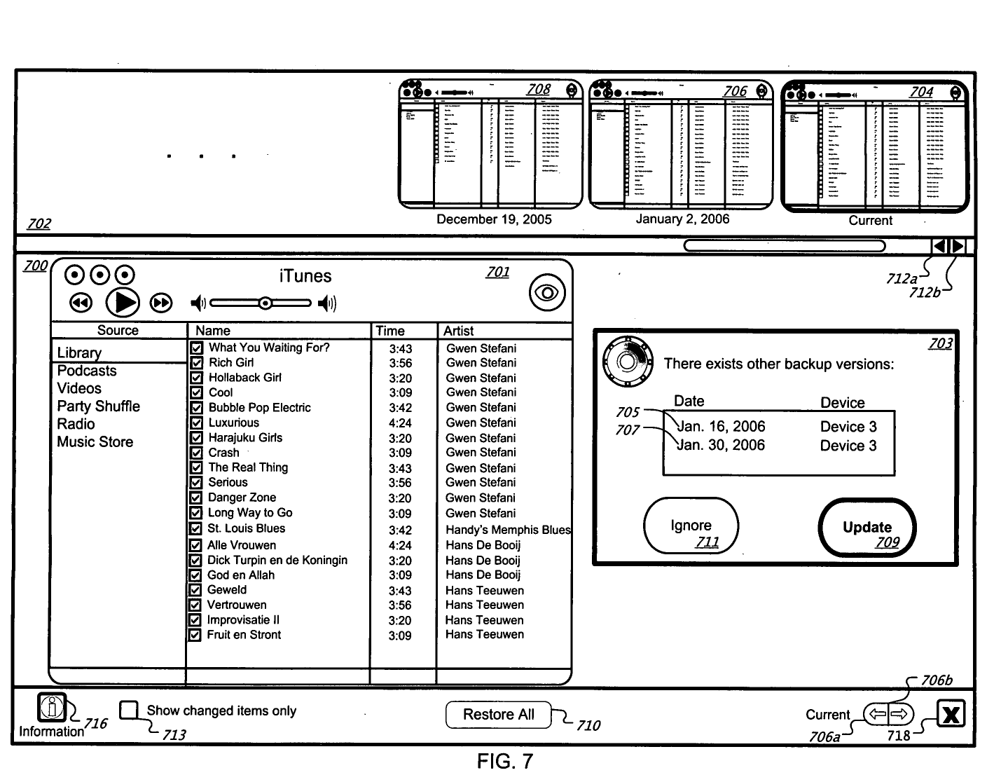

FIG. 7 is a screen shot depicting an example of a time machine user interface 700 generated by a time machine engine. The time machine interface 700 here includes a presentation window 701, a timeline 702, a pop-up window 703, and function buttons. As shown, the presentation window 701 is displaying the current iTunes™ application 605 from FIG. 6 because a “current” snapshot 704 has been selected (highlighted) in the timeline. As used herein, a snapshot refers to a backup element stored in an archive that includes a backup of selected items or content as specified by the backup component 117. The current snapshot can be a default selection. The presentation window 701 can show the contents corresponding to the currently selected snapshot, or a portion thereof. In this particular example, there is presented a date beneath each snapshot indicating when the snapshot was taken. In some implementations, the user can select items or content within the snapshots. For example, the user can select the snapshot 704, and next select one or more songs to back up using the time machine interface 700. In addition, the same selection functionality can be used in previous snapshots, such as snapshot 706 or snapshot 708, to restore missing data to the state associated with the current snapshot 704.

The timeline 702 can include a number of snapshots representing earlier versions or states of the iTunes™ library that have been backed up. Each snapshot provides a screenshot representation of the earlier version of the iTunes™ library at a particular point in time. In some implementations, the timeline 702 includes a visual representation of backup elements, such as a miniature version of the earlier state. The timeline can appear across the top portion of the time machine interface 700 (as shown). Alternatively, the timeline does not appear in the top portion of the time machine interface 700 until a user moves their cursor to (or otherwise activates) the timeline (e.g., by activating the top portion of the interface).

The time machine user interface can obtain data displayed in the timeline 702 from user-defined backup storage locations, such as primary storage devices (FIG. 5 pop-up window) or alternative storage devices. When backup operations have been performed using multiple backup devices, the user can synchronize one or more versions of backup data. For example, “Device 1” (FIG. 4) can be assigned as a primary storage device, while “Device 2” (FIG. 4) can be assigned as an alternative storage device. Both devices can contain multiple versions of backup data for one application and can be merged, synchronized or deleted upon user request. Upon initialization or startup, the time machine user interface 600 can detect other backup versions. For example, the pop-up window 703 shows that the time machine interface 600 has detected other backup versions. As shown in the pop-up window 703, a snapshot 705 and a snapshot 707 located on “Device 3” can be selected and added to the timeline 702. Here, the user chooses an “Update” button 709 to synchronize the backup data and merge selected snapshots into the timeline 702. Synchronizing backup data can present the user with a greater number of snapshots to choose between. In some implementations, the other backup files available to the user can be ignored. For example, the user can select an “Ignore” button 711 when presented with the pop-up window 703, thereby choosing to exclude other detected backup versions. In some implementations, the user can select a portion of detected backup versions for recovery in the timeline 702.

The time machine user interface 700 can also include function controls. For example, the interface 700 can include arrow buttons 706a and 706b to navigate the snapshots forward or backward. Arrow buttons 712a and 712b can allow the user to navigate to additional snapshots not shown in the current timeline window, thus there can be a larger number of snapshots from which to select.

The interface can include a restore all button 710 that, when selected, restores the view to the selected state represented by the selected snapshot. In some implementations, this terminates the session of the time machine. A user can select one element in a snapshot and then select the restore all button 710 to modify the current version of the element selected (e.g., restore the state of the view). For example, in iTunes™, the user can select a few songs to restore, and this can trigger the restore button to display a more precise message, such as “restore selection only.”

In one implementation, a changed items only checkbox control 713 filters the snapshots to show only those that differ from the current state. In one implementation, the checkbox control 713 does not refer to the incremental changes between snapshots in the timeline 702, but rather when invoked acts to omit those snapshots whose states are identical to the current state of the iTunes™ library from presentation in the timeline. For example, if the most recent snapshot 704 is identical to the snapshot 706 that occurs earlier in time, selecting the changed items only checkbox control 713, in one implementation, causes the time machine to cease displaying one of these versions, e.g., by removing the snapshot 706 from the timeline. This can help the user to view only snapshots that contain changes to the current directory.

An information button 716 provides information regarding the selected snapshot. In one implementation, selecting the information button 716 opens a panel display. The panel display can provide information including the date and time the snapshot was made, the location of actual contents in a snapshot, the size of the snapshot, and a comment section, to name a few examples. A close button 718 can be selected to exit the time machine and return the user to the desktop 600. In some implementations, the time machine engine can automatically close upon a particular snapshot being restored. In some implementations, the user can minimize the time machine for purposes of navigating to other applications, such as an email application or a web browser.

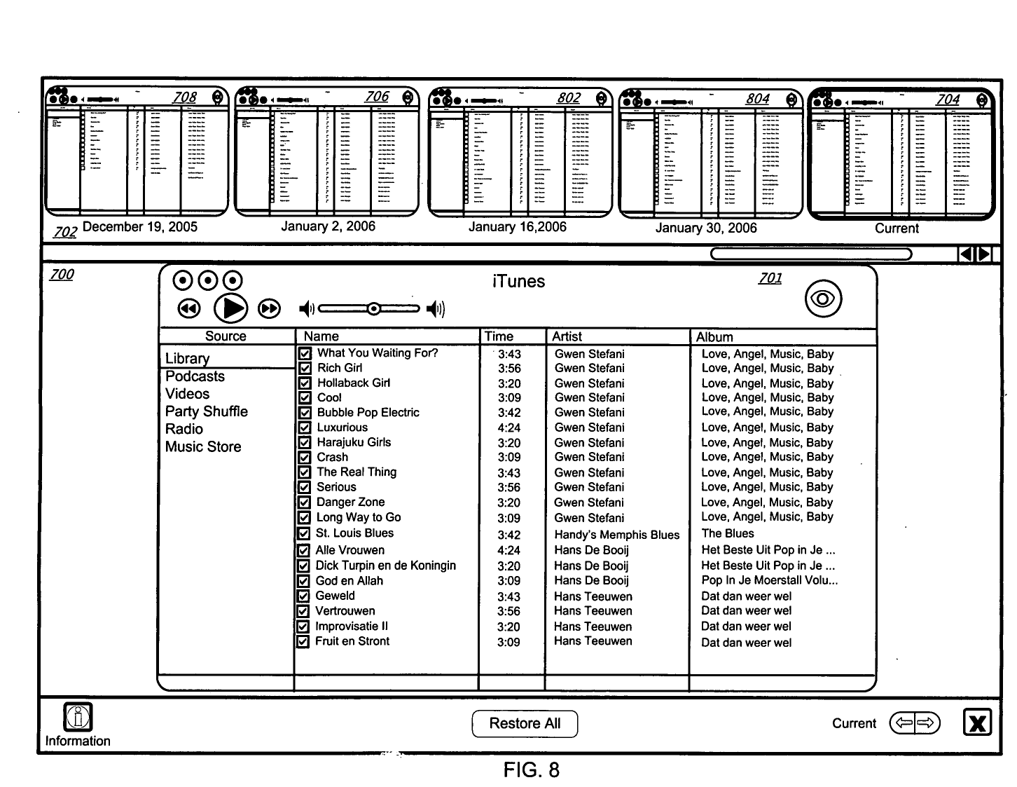

FIG. 8 is a screen shot depicting an example of a time machine user interface after additional backup information has been received from another device. As described above, a user has selected the “Update” button 709 (FIG. 7) to recover missing backup versions. The timeline 702 here shows previous snapshots (704, 706 and 708) and has added the other snapshots from one or more other devices device. In particular, timeline 702 now shows snapshots “Jan. 16, 2006” 802 (corresponding to backup version 705 in FIG. 7) and “Jan. 30, 2006” 804 (corresponding to backup version 707 in FIG. 7). In some implementations, the user can show unchanged data received from another device as a single snapshot. For example, a recovered snapshot and an existing snapshot can have the same data. A new snapshot can be presented in the time machine user interface having a new data combining the dates of the identical snapshots (as long as there are no snapshots having different data having a date between the two identical snapshots). For example, the snapshot 705 and the snapshot 706, having identical data, can be replaced by a new snapshot named “Jan. 2, 2006-Jan. 16, 2006.”

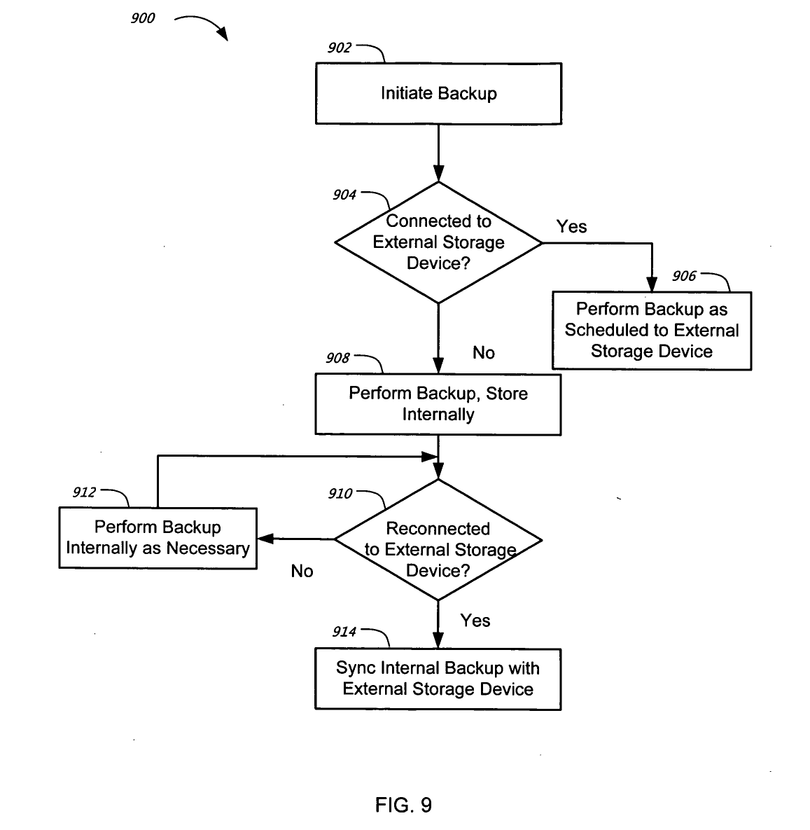

FIG. 9 is a flow diagram of exemplary operations 900 illustrating a multi-device archive management scenario. The operations 900 can be performed by a processor executing instructions stored in a computer program product. The operations 900 begin in step 902 with initiating a backup operation of data. For example, a user can choose to back up files or folders based on a particular time schedule, and the time machine engine can begin the backup operation according to the user specified time schedule. Alternatively, the backup operation can be performed according to a programmatic, rule based, or system defined time schedule. In step 904, the operations comprise detecting whether or not a computer system is connected to an external storage device. For example, a computer system running the time machine engine can detect whether or not the system is connected to a primary storage device, secondary storage device or any other external storage device, such as attached storage drives or remote servers. In some implementations, a user can predetermine which device to select over another device for preferred storage. When the computer system is connected to an external backup device, a backup operation can be performed as scheduled, in step 906. If, however, the system is not connected to an external backup device, the system can perform the back up and store the backup data internally (e.g., locally on the computer system) in step 908. In one implementation, the initial internal backup is a full backup, while subsequent internal backups can store the difference between several versions of data.

Backup operations can continue to be performed internally, as instructed, or until an external storage device is reconnected. In step 910, a query can be sent to a processing device, such as the backup management engine 216, for example, to determine whether or not the system has been reconnected to an external storage device. If the system is determined to be unconnected to external storage, internal backup operations can continue, in step 912 utilizing internal storage.

In one implementation, the time machine engine can continually assess connection to external storage devices. Alternatively, the system can be notified when a connection has been established with an external storage device. When the system determines that a connection has been reestablished to the external storage device, the time machine engine can synchronize internal backup data with backup data stored on the connected external storage device, in step 914. For example, with respect to the example in FIG. 6, “Device 1” is initially disconnected and “Device 2” (whether internal or external) is used instead. This creates multiple versions of system backup data on two separate devices. Upon reconnecting to “Device 1”, the time machine engine synchronizes the backup data into one version including both sets of backup data. Thus, this lets the user have an organized version of snapshots on a single device and a larger number of snapshots to choose between.

Those of ordinary skill in the art will recognize that the management technique described above with reference to internal and external storage is merely exemplary. The management technique is applicable to other memory structures. In one implementation, the management technique is used to control the storage of information on a primary back-up device and an alternate back up device, both of which can be located at a same or different location. Further, the back-up device and alternate back-up device can represent different portions of a singular device.

In the above description, for purposes of explanation, numerous specific details are set forth in order to provide a thorough understanding. It will be apparent, however, to one skilled in the art that implementations can be practiced without these specific details. In other instances, structures and devices are shown in block diagram form in order to avoid obscuring the disclosure.

In particular, one skilled in the art will recognize that other architectures and graphics environments can be used, and that the examples can be implemented using graphics tools and products other than those described above. In particular, the client/server approach is merely one example of an architecture for providing the functionality described herein; one skilled in the art will recognize that other, non-client/server approaches can also be used. Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

An apparatus for performing the operations herein can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD ROMs, and magnetic optical disks, read only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it can prove convenient to construct more specialized apparatuses to perform the method steps. The required structure for a variety of these systems will appear from the description. In addition, the present examples are not described with reference to any particular programming language. It will be appreciated that a variety of programming languages can be used to implement the teachings as described herein. Furthermore, as will be apparent to one of ordinary skill in the relevant art, the modules, features, attributes, methodologies, and other aspects can be implemented as software, hardware, firmware or any combination of the three. Of course, wherever a component is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present description is in no way limited to implementation in any specific operating system or environment.

The subject matter described in this specification can be implemented as one or more computer program products, i.e., one or more modules of computer program instructions encoded on a computer readable medium for execution by, or to control the operation of, data processing apparatus. The instructions can be organized into modules (or engines) in different numbers and combinations from the exemplary modules described. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

While this specification contains many specifics, these should not be construed as limitations on the scope of what may be claimed, but rather as descriptions of features specific to particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A method comprising:
initiating a backup operation for a system, where the backup operation is configured to store backup data to a storage device;
determining whether the system is coupled to the storage device; and
storing backup data locally if the system is not coupled to the storage device.

2. The method of claim 1, further comprising:
determining that the system is re-coupled to the external storage device; and
updating the external storage device with the internally stored backup data.

3. The method of claim 1, where storing backup data internally includes storing a full copy of data to be included in the backup.

4. The method of claim 1, where storing backup data internally includes storing changed data from a previous backup operation.

5. The method of claim 1, where storing backup data includes storing data in as a hierarchical file system.

6. The method of claim 1, where initiating the backup operation includes initiating the backup operation according to a schedule.

7. The method of claim 1, where initiating the backup operation includes initiating the backup operation according to one or more triggering events.

8. The method of claim 1, where updating the external storage device includes copying backup data from the system to the storage device.

9. The method of claim 1, further comprising:
storing additional incremental backup data locally until re-coupled to the storage device.

10. The method of claim 1, where determining whether the system is coupled includes detecting a presence of one or more storage devices.

11. The method of claim 1, where determining whether the system is coupled includes receiving a user input indicating that the system is not coupled to a storage device.

12. The method of claim 1, further comprising:
receiving a user input to store backup data locally.

13. The method of claim 1, where the storage device is external to the system.

14. The method of claim 1, where storing the backup data locally includes storing the backup data internally.

15. A computer program product, encoded on a computer-readable medium, operable to cause data processing apparatus to perform operations comprising:
initiating a backup operation for a system, where the backup operation is configured to store backup data to a storage device;
determining whether the system is coupled to the storage device; and
storing backup data locally if the system is not coupled to the storage device.

16. A method comprising:
initiating a backup operation for a system, where the backup operation is configured to store backup data to a storage device;
determining whether the system is coupled to the storage device; and
storing backup data on an alternative storage device if the storage device is unavailable.

17. A system comprising:
means for initiating a backup operation for a system, where the backup operation is configured to store backup data to a storage device;
means for determining whether the system is coupled to the storage device; and
means for storing backup data locally if the system is not coupled to the storage device.

18. A method comprising:
disconnecting a device from a first remote storage device;
storing backup data locally while the remote storage device is disconnected;
coupling a second remote storage device to the device; and
syncing the locally stored backup data with backup data stored on the second remote storage device.

19. The method of claim 18, where the first and second storage devices are the same storage device.

20. The method of claim 18, where syncing includes comparing the locally stored backup data with the backup data stored on the remote storage device and storing changed data from the data stored on the remote storage device.

21. A method comprising:
providing a device with local storage;
providing a remote storage device, the remote storage device being coupled intermittently with the device;
providing a backup application for storing a state of the device or a state of applications executing on the device;
determining if the device is coupled to the remote storage device;
if the device is coupled to the remote storage device, store data from backup application on the remote storage device;
if the device is not coupled to the remote storage device, store data from the backup application on the local storage.

22. The method of claim 21, further comprising:
if the device is re-coupled to the remote storage device, syncing backup data stored on the local storage with backup data stored on the remote storage device.

23. A method comprising:
defining a criterion for capturing a state of a view of a user interface of a device;
capturing the state of the view in accordance with the criterion;
determining if the device is coupled to a remote storage device;
if the device is coupled to the remote storage device, store the captured state of the view on the remote storage device; and
if the device is not coupled to the remote storage device, store the captured state of the view locally on the device.

24. The method of claim 23, further comprising:
receiving a prompt to suspend presentation of a current view and present a captured view; and
reinstating the captured view into the current view of the user interface.
